(19) United States
(12) Patent Application Publication
(10) Pub. No.: US 2005/0044802 A1
(43) Pub. Date: Mar. 3, 2005

(54) Method and module for improving the lifetime of metal fluoride optical elements

(76) Inventors: Robert A. Bellman, Painted Post, NY (US); Dana C. Bookbinder, Corning, NY (US); Amy L. Rovelstad, Ithaca, NY (US); Kamal K. Soni, Painted Post, NY (US); Susan L. Schiefelbein, Ithaca, NY (US)

Correspondence Address: CORNING INCORPORATED, SP-TI-3-1, CORNING, NY, 14831, US

(21) Appl. No.: 10/873,049

(22) Filed: Jun. 22, 2004

Related U.S. Application Data
(60) Provisional application No. 60/498,115, filed on Aug. 27, 2003.

(51) Int. Cl. B24D 3/02; C09C 1/68; C09K 3/14; G03C 5/00

(52) U.S. Cl. 51/307

(57) ABSTRACT

The invention is directed to improving the lifetime of optical assemblies by placing such assemblies in a housing and placing a “getter” material within the housing to remove substances that affect the surface of the optical elements used in such assemblies. The “getter” materials are those materials that can remove H₂O and O₂ from the operating environment of the optical element. The invention is useful in protecting the optical elements of below 250 nm laser lithography systems from damage due to pitting.

### CLAIM OF PRIORITY

This application claims the priority benefit of U.S. Provisional Application No. 60/498,115 filed Aug. 27, 2003.

### FIELD OF THE INVENTION

This invention is directed to improving the lifetime of the optics used in laser systems for the transmission of electromagnetic radiation in the ultraviolet, visible and infrared regions of the electromagnetic spectrum. The invention is particularly useful in laser systems having wavelengths less than 250 nanometers (nm), and especially in laser systems used in the area of laser lithography.

### BACKGROUND OF THE INVENTION

The use of high power lasers, for example, those with a power density (fluence) above 80 mJ/cm² with pulse lengths in the low nanometer range, can degrade the optics used in laser lithography systems. T. M. Stephen, B. Van Zyl, and R. C. Amme, “Degradation of Vacuum Exposed SiO2 Laser Windows”, SPIE Vol. 1848, pp. 106-109 (1992), report on the surface degradation of fused silica in Ar-ion laser. More recently, it has been noticed that there is optical window surface degradation in high peak and average power 193 nm excimer lasers using window materials made from substances other than silica. Such degradation has been found to occur both on the interior surface of the windows of the laser chamber, on the exterior surface of such windows and also on the surfaces of addition optical elements that are used in conjunction with the laser chamber. For example, on the surfaces of focusing lenses made of optical materials of formula MF₂ where M is Ca, Mg, Ba and Sr. It is of concern that such degradation will be more severe when existing optical materials are used in 157 nm and other low wavelength (<250 nm) laser systems.

CaF₂ is an important optical material that is used in below 250 nm laser lithography systems. In particular, CaF₂ is a favored material for UV lithography systems due to its high transmission at wavelengths of 250 nm or less, for example, 248, 193 and 157 nanometers. CaF₂ is used for optical windows, lenses, beam splitters, photomasks and other optical components or elements for transmitting light. However, the lifetime of CaF₂ optics, as is the case with MgF₂ optics, is limited when exposed to high intensity (fluence) UV radiation. Under such conditions pitting can occur on the surface of CaF₂ optical element. This pitting degrades the quality of the optical element, and can result in decreased transmittance, increased birefringence and other problems familiar to those skilled in the art. Consequently, it is desirable to find a solution to the degradation problem that will either eliminate the problem or will greatly extend the durability of the optical elements, and consequently the length of time that existing and future optical windows can be used.

Accordingly, it is proposed that a “getter” material be used to remove oxygen and/or moisture (water vapor) from the environment surrounding the optics of low wavelength laser optics. U.S. Pat. Nos. 5,513,198 and 5,392,305 to Jakobson, and U.S. Pat. No. 5,629,952 to Bartholomew et al. describe the use of a getter material to remove organic impurities, in the presence of oxygen, from the atmosphere contained in a hermetically sealed container housing a semiconductor laser; but do not describe the removal of oxygen and/or moisture from such atmosphere.

### SUMMARY OF THE INVENTION

In one aspect, the invention is directed to improving the lifetime of optical assemblies by placing such assemblies in a housing and placing a “getter” material within the housing to remove substances that affect the surface of the optical elements used in such assemblies. The “getter” materials are those that can remove H₂O and O₂ from the operating environment of the optical element. Examples of gaseous getter materials, without limitation, include CF₄, SiF₄, SiCl₄, CCl₄, CClF₃, BrCF₃, HCF₃, COF₂, SOF₂, and other halogenated compounds that are gases at and above ambient temperature and that don't form solid compounds with Ca in the environment of the optical assembly. Examples of other getter materials that can be placed within the housing are solids or liquids that can remove H₂O. Such materials include zeolites, powders of formula MF₂ where M is Ca, Ba, Mg, Sr, Pb, Zn and mixtures thereof, powders of formula M′F where M′ is Li and Na and mixtures thereof, additional substances such as AlF₃, TiF₄, ZrF₄, and similar substances known in the art to absorb and react with water and/or oxygen and that do not form solid compounds with Ca in the environment of the optical assembly.

In another aspect, the invention is directed to improving the lifetime of optical assemblies by placing such assemblies in a housing, placing a solid “getter” material within the housing and heating the solid getter material to remove substances that affect the surface of the optical elements used in such assemblies.

In another aspect, the invention can be used with optical assemblies having coated optical elements. For example, MgF₂ optical elements having a CaF₂ coating thereon or high purity silica optical elements having an MgF₂ coating thereon.

The invention is also directed to a CaF₂ optical assembly module useful for optical lithography, said assembly module comprising:

a hermetically sealable housing having therein one or a plurality of optical elements made from an optical material;

sealable ports in said housing for the entry and exit of a gas comprising an inert gas;

at least one of a solid, a liquid and/or a gaseous getter material capable of reacting with and removing oxygen and/or water vapor from the atmosphere with said housing;

a receptacle within said housing for holding said liquid or said solid getter material when said liquid or solid material is present within said housing

wherein any gaseous material admitted into or contained with said housing is a fluorine-free, that is, an F₂-free gas.

The invention is further directed to a method for reducing the oxygen and water vapor content in the atmosphere surrounding an optical system containing optical elements made of material of formula MF₂ and M′F, where M is magnesium, calcium, barium or strontium and M′ is lithium or potassium, said method comprising:

placing at least one optical element of formula MF₂ or M′F in a hermetically sealable housing having therein one or a plurality of optical elements made from an optical material;

flowing a gas comprising an inert gas through sealable entry and exit ports in said housing;

placing within or admitting into said housing at least one of a solid, a liquid and/or a gaseous getter material capable of reacting with and removing oxygen and/or water vapor from the atmosphere with said housing; and

removing oxygen and/or water vapor from the atmosphere within said housing by reaction of said at least one getter material with the oxygen and/or water that may be present within said housing;

wherein any gaseous material admitted into or contained with said housing is a fluorine-free, that is, an F₂-free gas, and

wherein when a gaseous getter material is admitted into said housing, said gaseous getter material may be admixed with said inert gas prior to entry into said housing or may be admitted separately into said housing.

### BRIEF DESCRIPTION OF THE DRAWINGS

FIG. 1 is illustrates the proposed mechanism for surface damage of CaF₂ elements in an assembly of elements.

FIG. 2 illustrates the method and assembly of the invention providing improved CaF₂ stability.

FIG. 3 illustrates the critical pH₂O required for the formation of Ca(OH)₂ (s) from CaF₂ (s) by reaction with H₂O.

FIG. 4 illustrates the critical pO₂ required for the formation of CaO (s) from CaF₂ by reaction with O₂.

FIG. 5 shows the thermochemical calculation scheme using FACT software.

FIG. 6 illustrates an embodiment of the invention in which a wafer of material being lithographed is located outside the hermetically sealed housing used in practicing the invention.

FIG. 7 illustrates an embodiment of the invention in which a wafer of material being lithographed is located inside the hermetically sealed housing used in practicing the invention.

FIG. 8 is an optical photograph at 44× magnification of CaF₂ optical element illustrating pitting on the face upon which laser radiation is incident (See FIG. 1).

FIG. 9 is an optical photograph at 22× magnification of CaF₂ optical element illustrating pitting on the face upon which laser radiation exits the element (see FIG. 1).

### DETAILED DESCRIPTION OF THE INVENTION

As used herein, the terms “optical components” and “optical materials” include, among others, optical elements such as the chamber windows used in laser systems, beam splitters, optical lenses and other optical elements used in optical lithography systems. Included among the optical materials are optical materials that are single- or mono-crystals made by methods known in the art that have been formed into optical components such as windows, prisms, beams splitters, lenses and other optical elements that are used in optical lithography systems. For example, monocrystals of MF₂ crystals can be made by the Stockbarger method (see J. Opt. Soc. Am. 14, 448 (1927)); the Bridgeman-Stockbarger, Kyropulos and Czochralski methods; the methods described in U.S. Pat. Nos. 6,485,562, 6,402,840, 6,364,946, 4,521,272 and 4,404,172; and other methods known in the art. In addition, as used herein the terms “fluorine-free gas” and “fluorine-free atmosphere” mean a gas, mixture of gases or an atmosphere that contains 1 ppm or less F₂ (molecular fluorine gas).

Also herein, optical materials or substrates made from monocrystals of calcium fluoride, CaF₂, are used to exemplify the invention and the methods used to accomplish it. It should be understood that optical substrates made from other materials of formula MF₂ as described herein can also be used. Materials of formula MF₂ include magnesium fluoride, calcium fluoride, barium fluoride and strontium fluoride. In addition, the invention can be used in visible and infrared systems and the optical material used therein may be high purity silica or materials of M′F where M′ is lithium or potassium. In all cases mixed metal fluoride elements are included. For illustration purposes, an example of a mixed metal optical element is one made of calcium fluoride and barium fluoride (Ca₁₋ₓBaₓF₂ or K, where 0<x<1).

As has been described above, CaF2 optics can be plagued with surface degradation such as pitting during the course of their use. While not adhering strictly to any particular theory, it is believed that the failure mechanism involves the formation of a surface oxide and/or hydroxide (or other derivative forms such as CaF(OH)) on the CaF₂ element from oxygen and/or water present in the atmosphere within an assembly, including a purge gas when such are used with the assembly. Concentrations of water or oxygen in the parts per billion range in the CaF₂ environment are thermodynamically sufficient to cause such surface pitting. Under high intensity UV radiation the surface oxide or hydroxide species absorbs light and heats up to a point where surface ablation results. That is, species such as CaF₂, CaF(OH), Ca(OH)₂ and CaO are removed from the surface of the optical element. Repetition of the foregoing steps results in pitting of the surface of the CaF₂ optical element.

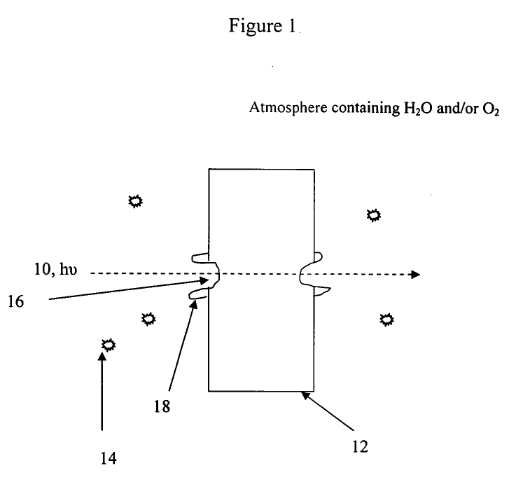

A schematic of the proposed failure mechanism is shown in FIG. 1. UV light 10 in the form of high intensity laser radiation impinges on a metal fluoride optical element 12 such as the illustrated CaF₂ optic. The optical element heats up and reacts with the oxygen and/or water contained in the atmosphere surrounding the element. As the UV light 10 continues to impinge on optical element 12, CaF₂ material 14, along with any reaction products such as CaF(OH), CaO, etc., is ablated from the surface of the optical element and a pit 16 is formed on the surface of optical element 12. Ablated material 14 can also be re-deposited as illustrated at 18. The resulting pit and/or re-deposited material can render optical element 12 unusable for lithographic purposes by causing distortion of the impinging UV light 10. A possible sequence of events for the pitting is illustrated by the following reactions (1)-(4).
CaF₂ surface+H₂O(g)→Surface CaO (and/or CaF(OH)+HF (1)
CaF₂ surface+2 H₂O(g)→Surface Ca(OH)₂+2 HF (2)
CaO, CaF(OH), Ca(OH)₂+UV hυ→Absorbs UV and generates heat (3)
Heated Surface→Ablation of CaF₂, CaF(OH), CaO, Ca(OH)₂ material (4)
Although reactions 1 and 2 are thermodynamically favored under typical conditions in an optical housing, they may be kinetically hindered at room temperature. Nonetheless, reactions 1 and 2 are likely to proceed at room temperature since:
(a) water can dissociatively chemisorb on the surface to form oxide and hydroxide species;
(b) the reactivity of the CaF₂ surface is greatly enhanced after irradiation; and
(c) photolysis of O-containing compounds such as O₂, H₂O and NOₓ can produce very reactive radicals and ozone.

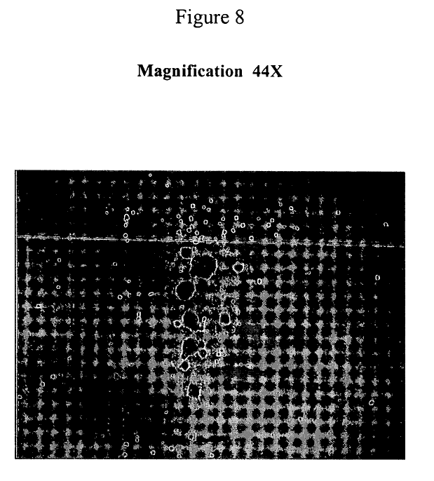

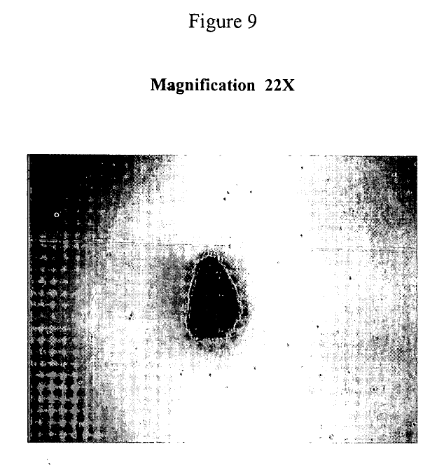

An example of the observed damage is shown in FIGS. 8 and 9. For example, radical and ozone formation by photolysis of O-containing compounds such as O₂, followed by CaF₂oxidation by the radicals/ozone can also lead to surface damage such as pitting. For example, radicals and ozone can be formed as follows.
O₂+hυ→O.+O. (radicals)
O.+O₂→O₃ (ozone)

Getter gas such as those described herein can significantly improve the resistance of metal fluoride element in an inert atmosphere (N₂, Ar, Kr, etc.) by consuming oxygen radicals and ozone. For example, if the getter gas is CFCl₃ the following radical/ozone scavenger reactions can occur.
CFCl₃+hυ→CFCl₂.+Cl. (radicals)
Cl.+O₃→ClO+O₂
ClO+O.→O₂+Cl.

FIGS. 8 and 9 illustrate the damage that can occur when high intensity laser radiation strikes the surface of a metal fluoride crystal (in this case a CaF₂ crystal) in the presence of water and/or oxygen. FIG. 8 illustrates the pitting that can occur on the face upon which the laser radiation is incident. FIG. 9 illustrates the damage that can occur on the face from which laser radiation exits the metal fluoride element. Removing water vapor and/or oxygen, or minimizing them to a very low amount, from the environment of the metal fluoride element by the use of a getter agent precludes or minimizes pitting of the element's surface.

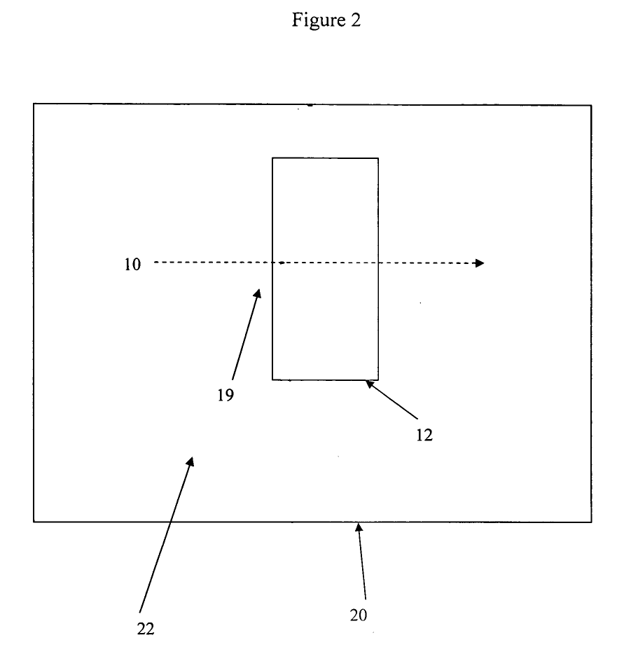

Referring now to FIG. 2, to avoid the pitting caused by the presence of oxygen and/or water, the claimed invention encloses the optic in a housing 20 containing an oxygen/moisture getter material 22, preferably a getter gas. The housing can also contain an inert or purge gas (not numbered). Light impinging on optical element 10 heats the element, but in the absence of oxygen and/or water due to the presence of getter material no reaction products are formed and the surface of optical element 10 is not pitted as illustrated in FIG. 1. As an example, the following reactions (5-8) can occur when CF₄ is used as the getter gas.
CF₄+2 H₂O→CO₂+4 HF (5)
CF₄+CaO→CO₂+CaF₂ (6)
CF₄+CaF(OH)→CO₂+CaF₂ (7)
CF₄+Ca(OH)₂→CO₂+2 HF+CaF₂ (8)

A simulation of the environment in a housing containing oxygen and/or moisture was conducted using FACT thermochemical software and databases (FactSage version 5.1, <www.factsage.com>, Ecole Polytechnique, Montreal, Canada 2002) to determine the minimum O₂ and H₂O concentrations for formation of CaO and Ca(OH)₂ from pure solid CaF₂. The results indicate that the required concentrations are extremely small. Consequently, it is extraordinarily difficult, in a thermochemical sense, to suppress the formation of Ca(OH)₂ and especially CaO from CaF2 using an inert purge gas (e.g. N₂) without getters.

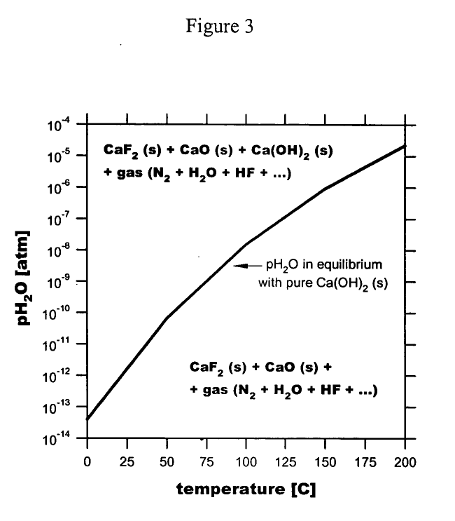

FIG. 3 illustrates the critical pH₂O (partial pressure in atmospheres of H₂O) required for the formation of Ca(OH)₂ (s), where “s” means solid, from CaF₂ via reaction with the H₂O in a N₂ purge gas. The solid line in FIG. 3 indicates the pH₂O in equilibrium with Ca(OH)₂ (s). Ca(OH)₂ (s) can exist above this line but not below it. That is, Ca(OH)₂ is thermodynamically stable everywhere above the solid line. This restriction gives the thermochemical requirement that to prevent formation of Ca(OH)₂ the pH₂O in the N₂ atmosphere must be kept below the solid line (that is, the pressure must be <10⁻¹² atm. H₂O at room temperature). It is important to note that even for pH₂O<10⁻¹² atm., CaF₂ (s) can react with H₂O (g), where “g” means gas, to form CaO (s).

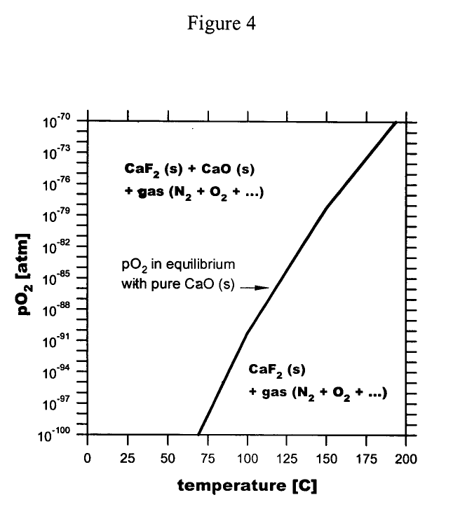

FIG. 4 illustrates the critical pO₂ (partial pressure in atmospheres of O₂) required for the formation of CaO (s) from CaF₂ via reaction with H₂O or O₂ in an N2 purge gas. The solid line in FIG. 4 illustrates pO₂ in equilibrium with CaO (s). That is, CaO (s) can exist above this line but not below it. CaO is thermodynamically stable everywhere above the solid line. This indicates that the thermochemical requirement to prevent formation of CaO is that the pO₂ of the N₂ atmosphere must be kept below the solid line (that is, less than approximately 10⁻¹⁰⁰ atm. O₂ at room temperature).

Since it is impossible to achieve such small concentrations of O₂ and/or H₂O in an inert purge gas without the use of getters, the above data indicates that both CaO (s) and/or Ca(OH)₂ (s) are thermochemically favored in a CaF₂ laser system purged with an inert gas like N₂. Consequently, that data supports the hypothesis that formation of oxides and/or hydroxides are responsible for the observed ablation as illustrated in FIG. 1. The amount of H₂O and O₂ in the purge gas can be reduced to very low levels by pre-drying using techniques known in the art; for example, by passing the gas through a heated column of finely divided copper precipitated on Kieselguhr (diatomaceous earth) or other finely divided, inert, nonflammable material.

The reliability and lifetime of CaF₂ optical assemblies can be increased by adding a getter material to remove H₂O and O₂ from the CaF₂ optical assembly environment. Accordingly the invention provides an optical assembly having a CaF₂ element or plurality of such elements; a housing surrounding the optical assembly; a gas atmosphere in contact with the CaF₂ element and a “getter” for the removal of moisture (water and/or oxygen from the atmosphere within the housing and/or from the surface of the optical elements contained within the housing.

The getter material can be a solid, a liquid or a gas. When the getter is gaseous, the getter may constitute a component of the gas atmosphere at a selected concentration in the range of less than 1% to 100%. When the gaseous getter is present at less than 100% of the atmosphere the remainder of the gas atmosphere may be an inert gas (for example, N₂, Ar, He or Kr) or a secondary getter gas (for example CO or CH₄) or a combination of an inert gas and a secondary getter gas. The gaseous getters, in addition to removing moisture and/or oxygen from the atmosphere within the housing, can also be capable of removing OH and O from the CaF2 optical surface. Examples of gaseous getter materials include, but are not limited to, CF₄, SiF₄, SiCl₄, CCl₄, CClF₃, BrCF₃, HCF₃, COF₂, SOF₂, Cl₂ and other halogenated compounds that are gases at ambient temperature. Additionally, the getter gas or gasses can also be heated or plasma activated to increase their reactivity. The heating can be done within the housing by heaters therein (not illustrated) or prior to admitting the gases into the housing. The getter gas can also be heated and/or converted into a plasma by the laser beam. When the getter gas is heated or converted into a plasma, the purge gas should be heated so that it does not rapidly cool the getter gas.

In addition to gaseous materials, the getter material may also be solid or liquid to remove water from the CaF₂ optical assembly environment. Examples of such materials include zeolites. A preferred solid getter is a dry MF₂ powder such as CaF₂ powder. The moisture and/or oxygen present in the atmosphere will be preferentially removed by the CaF₂ powder. A CaF₂ optical part has limited surface area. For example, a 10 cm diameter part would have a surface of approximately 78 cm². In contrast, a CaF₂ powder can have a surface that can be in the hundreds of square meters/gram. Since the materials are the same, the CaF₂ powder becomes preferable for removing the water or oxygen because of its high surface area relative to the optical part. Heating the CaF₂ powder speeds its reaction with water and oxygen. Consequently, when a powder is used to remove water or oxygen, a receptacle for holding the powder is also included as part of the invention. Other metal fluoride powders can also be used as solid getter materials. Examples of such additional solid materials include LiF, NaF, AlF3, PbF2, ZnF2, PF5, TiF4, ZrF4, and other solid fluorides known in the art. While the examples herein are directed to UV lithographic systems, the getters as described herein can also be used in infrared and visible light applications. We also propose this getter technology could be beneficial to MgF2, BaF2 and other optical assemblies including coated optics. Getter technology could also be used for visible and infra-red optical applications.

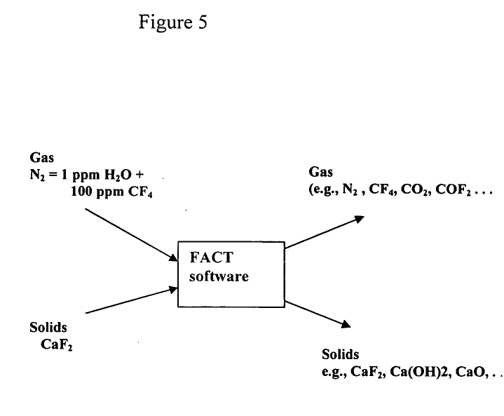

FIG. 5 illustrates the thermochemical calculation that was performed using the FACT software for a CaF₂ optical element in a N₂ atmosphere containing a getter gas. The results show that while CaO (s) and Ca(OH)₂ (s) can be formed when the purge gas is N₂ containing low levels of water (low levels are approximately 1 ppm by volume or less), both are suppressed when 100 ppm by volume CF₄ is added to the N₂ purge gas. Additional calculations indicated in order to be effective for suppressing the formation of CaO and/or Ca(OH)₂, the level of CF₄ required for suppression is approximately the level of the water and/or oxygen that is present in the N₂ purge gas. The CF₄ suppresses the formation of CaO and Ca(OH)₂ by reaction with O₂ and H₂O to form the very stable products COF₂ (carbonyl fluoride), CO₂ and/or HF. Other getter gases operate in a similar manner. For example, if the getter gas is COF₂, the likely reaction products are CO₂, CF₄ and HF.

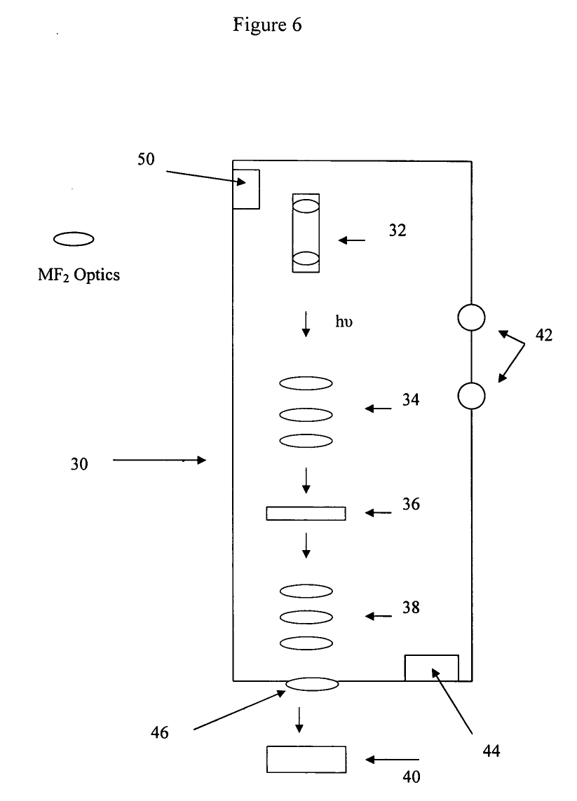

FIG. 6 illustrates the invention. A laser system, illustrated in a highly simplified manner as consisting of a laser radiation (hυ) source 32, system illumination optics 34, a lithographic mask 36 and projection optics 38, is housed in a hermetically sealable housing 30. Housing 30 has a plurality of ports 42 (only two are illustrated) for the entry and exit of gaseous substances, for example a purge gas and/or a getter gas; a receptacle 44 for containing a solid or liquid getter material, and an optional circulating fan that can be used as needed, for example, when a purge gas is not being flowed through the housing. The housing 30 also has an optical element 46 through which the pattern can be projected onto wafer 40. The lithographic pattern 36 can be held on a slidable holder 37 (not illustrated) that is sealable to the housing. This will facilitate easy changing of lithographic pattern and allow multiple patterns to be projected onto a single wafer.

In an alternative embodiment (not illustrated), the laser radiation source 32 of FIG. 6 is located outside the housing 30 and laser radiation from the source 32 is admitted to the housing through an optical element 31 (not illustrated) located at the top of the housing. The laser radiation passes through element 31 to elements 34 as illustrated in FIG. 6.

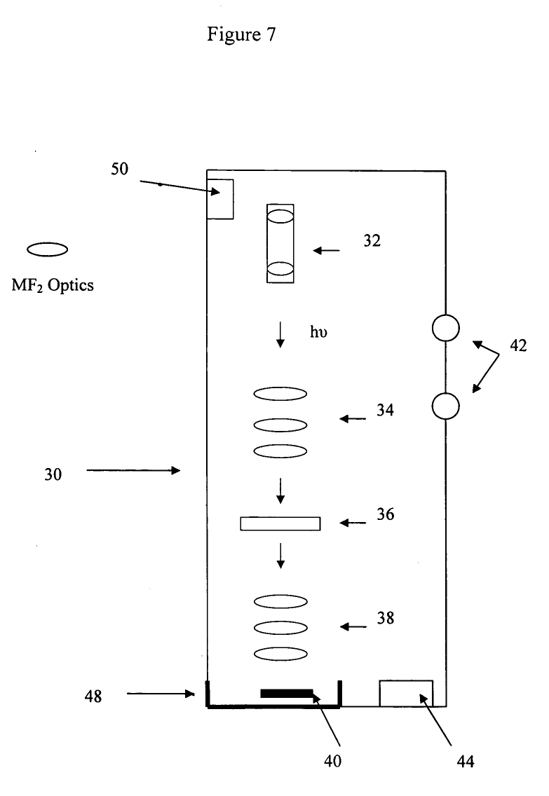

In an alternative embodiment as illustrated in FIG. 7 the wafer 40 is held on a slidable tray 48 (bold lines) to facilitate changing wafers. Tray 48 is sealable against the housing to prevent escape or contamination of the atmosphere within the housing. In this embodiment optical element 46 of FIG. 6 is not required. In all embodiments of the invention the housing (or minimally the inside of the housing) and materials located inside the housing that hold optical elements, the laser source and similar elements are made of materials or are coated with materials that are chemically inert to the effect of any getter materials that are used in practicing the invention. Not illustrated in FIGS. 6 and 7 are the source of a getter gas or the purge gas

In practicing the invention an inert gas, for example, N₂, Ar or Kr, containing a gaseous getter material as described herein is admitted into the housing through a first port 42 and exits through a second port 42. Alternatively, the inert gas and the getter gas can be admitted through separate ports and exit through a common port. The getter gas can be present in any concentration ranging from less than 1% to 100%. Preferably, the amount of getter gas is kept at a low level; for example, a maximum level in the range of 5-10%, preferably 5% or less. As indicated by the thermochemical calculations, getter gas levels on the order of 100 pm may be sufficient. However, the exact amount of getter gas required will be determined by the amount of oxygen and water vapor present in the purge gas. Preferably, a purge gas containing less than 1000 ppm (0.1%) getter gas is used during lithographic operations.

Prior to beginning operation of the lithographic system, high levels of getter gas may be admitted to the housing to cleanse the surfaces therein, including those of the laser system and its elements, of residual oxygen and water vapor. This can be done by flowing high concentrations of getter gas through the housing or by filling the housing with the high concentrations of getter gas and sealing the housing for a predetermined time, for example, 10 minutes to 6 hours, or longer, to enable the getter gas to react with the oxygen and water vapor therein. Fan 50 maybe operated during this period to insure that the getter gas is circulated through the housing. The exact time the high concentration of getter gas is maintained in the housing may be determined by sampling and analyzing the atmosphere within the housing. Subsequently, the housing is swept with a purge gas containing low levels of getter gas prior to the commencement of lithographic operations. During lithographic operations the purge gas containing the getter gas at levels indicated above is continually swept through the housing.

In an alternative embodiment, a purge gas containing a getter gas is used in combination with a solid or liquid getter material. This solid or liquid getter material is contained in receptacle 44. The top of receptacle 44 is open to the interior of housing 30, though it may be covered by a screen or mesh to prevent any material in the receptacle from spilling into the housing. In particular, a mesh should be used if a liquid getter material is used. In the case of solid getter materials, these may be contained in a permeable container that has opening of sufficient diameter to allow oxygen or water vapor to penetrate the container and react with the getter material contained therein. The permeable container holding the getter material is placed in the receptacle. The receptacle may be heated to increase the reactivity of the getter material. Alternatively, the receptacle is configured to include a blower that forces the atmosphere within the housing over and through the getter material. The use of a solid getter material is particularly useful for purging the system of bulk water and oxygen prior to beginning lithographic operations. This practice may avoid the use of high concentrations of getter gas as disclosed above to initially remove water vapor and oxygen present within the housing or on the elements therein. Again, the atmosphere within the housing may be sampled and analyzed to determine when a satisfactory level of oxygen and water vapor has been reached. When this level has been reached the receptacle containing the liquid or solid getter material may be sealed from the interior of the housing by the placement of a cover (not illustrated), for example, a slidable cover. Flow of a purge gas containing a getter gas can then be maintained throughout the lithographic process.

In another embodiment a solid or liquid getter material is initially used in conjunction with a purge gas to remove oxygen and water vapor from within the housing. Once the oxygen and water vapor have been eliminated or reduced to acceptable levels, the flow of purge gas is stopped and the system is maintained by use of only the solid or liquid getter materials contained within the housing.

In another embodiment, the getter gas is heated (including plasma heating) or is converted into a plasma prior to mixing with the purge gas.

The foregoing examples of specific compositions, processes, articles and/or apparatus employed in the practice of the present invention are, of course, intended to be illustrative rather than limiting, and it will be apparent that numerous variations and modifications of these specific embodiments may be practiced within the scope of the appended claims.

1. A CaF₂ optical assembly module useful for optical lithography, said module comprising:
a hermetically sealable housing having therein one or a plurality optical elements made from an optical material;
sealable ports in said housing for the entry and exits of a gas comprising an inert gas;
at least one of a solid, a liquid and/or a gaseous getter material capable of reacting with and removing oxygen and/or water vapor from the atmosphere with said housing;
a receptacle within said housing for holding said liquid or said solid getter material when said liquid or solid mater is present within said housing
wherein any gaseous material admitted into or containing with said housing is an F₂-free gas.

2. The assembly according to claim 1, wherein the gaseous getter material is one or more material selected from the group consisting of CF₄, SiF₄, SiCl₄, CCl₄, CClF₃, BrCF₃, HCF₃, COF₂, SOF₂, and other halogenated compounds that are gases at ambient temperature and that don't form solid compounds with Ca in the environment of the optical assembly.

3. The assembly according to claim 3, wherein the getter gases additionally include carbon monoxide and/or methane.

4. The assembly according to claim 1, wherein the solid getter material is selected from the groups consisting of zeolites and LiF, NaF, AlF3, PbF2, ZnF2, CaF2, PF5, TiF4, ZrF4 and other solid fluorides known in the art in powder form.

5. The assembly according to claim 1, wherein at least one of said optical elements is made from a material having formula MF₂ or M′F, where M is magnesium, calcium, barium or strontium and M′ is lithium or potassium.

6. The assembly according to claim 1, wherein at least one of said optical elements is made from a material having formula MF₂ where M is magnesium, calcium, barium or strontium.

7. The assembly according to claim 2, wherein at least one of the optical elements if CaF₂, the getter gas is CF₄, and the getter solid is CaF₂ powder.

8. The assembly according to claim 1, wherein said optical elements are optical elements required for an optical lithography system operating at less than 250 nm wavelength, excluding the less than 250 nm radiation source.

9. The assembly according to claim 1, wherein said optical elements are optical elements required for an optical lithography system operating at less than 250 nm wavelength, including a less than 250 nm radiation source.

10. A method for reducing the oxygen and water vapor content in the atmosphere surrounding an optical system containing optical elements made of material of formula MF₂ and M′F, where M is magnesium, calcium, barium or strontium and M′ is lithium or potassium, said method comprising:
placing an optical element of formula MF₂ or M′F in a hermetically sealable housing having therein one or a plurality of optical elements made from an optical material;
flowing a gas comprising an inert gas through sealable entry and exit ports in said housing;
placing within or admitting into said housing at least one of a solid, a liquid and/or a gaseous getter material capable of reacting with and removing oxygen and/or water vapor from the atmosphere with said housing; and
removing oxygen and/or water vapor from the atmosphere within said housing by reaction of said at least one getter material with the oxygen and/or water that maybe present within said housing;
wherein any gaseous material admitted into or contained with said housing is an F₂-free gas, and
wherein when a gaseous getter material is admitted into said housing, said gaseous getter material may be admixed with said inert gas prior to entry into said housing or may be admitted separately into said housing.

11. The method according to claim 12, wherein the gaseous getter material is at least one material selected from the group consisting of CF₄, SiF₄, SiCl₄, CCl₄, CClF₃, BrCF₃, HCF₃, COF₂, SOF₂, and other halogenated compound that are gases at ambient temperature and that don't form solid compounds with Ca in the environment of the optical assembly.

12. The assembly according to claim 11, wherein the getter gases additionally includes carbon monoxide and/or methane.

13. The assembly according to claim 10, wherein the solid getter material is selected from the groups consisting of zeolites and LiF, NaF, AlF3, PbF2, ZnF2, CaF₂, PF5, TiF4, ZrF4 and other solid fluorides known in the art.

14. The method according to claim 10, wherein an inert gas containing a getter gas is flowed through the housing containing the optical elements for a selected time in the presence of a liquid or solid getter material prior to the using the elements for optical lithography, and after said selected time has expires the flow of inert gas containing the getter gas is ceased and the removal of oxygen and/or water vapor.

15. The method according to claim 10, wherein the getter gas is heated to increase its rate of reactivity.

16. The method according to claim 10, wherein the getter gas is plasma activated by plasma heating or conversion into a plasma.
